(19) United States
(12) Patent Application Publication
(10) Pub. No.: US 2013/0293505 A1
(43) Pub. Date: Nov. 7, 2013

(54) MULTI-DIMENSIONAL INTERACTION INTERFACE FOR MOBILE DEVICES

(71) Applicants: Lakshman Krishnamurthy, Portland, OR (US); David L. Graumann, Portland, OR (US); Sangita Sharma, Portland, OR (US); Jameson H. Williams, Portland, OR (US)

(72) Inventors: Lakshman Krishnamurthy, Portland, OR (US); David L. Graumann, Portland, OR (US); Sangita Sharma, Portland, OR (US); Jameson H. Williams, Portland, OR (US)

(21) Appl. No.: 13/996,471

(22) PCT Filed: Sep. 30, 2011
(86) PCT No.: PCT/US11/54393

§ 371 Date: Jun. 20, 2013

(51) Int. Cl. G06F 3/041

(52) U.S. Cl. CPC G06F 3/041
USPC 345/173

(57) ABSTRACT

Method and apparatus for multi-dimensional interaction interface for mobile devices. An embodiment of a mobile device includes a touch screen to provide a display and to generate a touch screen signal upon contact to the touch screen, a touch sensor to generate a touch sensor signal upon contact to the touch sensor, and a module to provide for cooperative operation of the touch screen signal and the touch sensor signal in providing input to the mobile device upon determining that an input to the touch screen indicates a multipoint input.

### TECHNICAL FIELD

Embodiments of the invention generally relate to the field of electronic devices and, more particularly, an apparatus, method, and system for a multi-dimensional interaction interface for mobile devices.

### BACKGROUND

Mobile devices, including cellular phones, smart phones, mobile Internet devices (MIDs), handheld computers, personal digital assistants (PDAs), and other similar devices, utilized for many different functions, and the input of information for these various functions may take different forms. A mobile device may include multiple different input elements, including, for example, a touch screen, input buttons, and similar elements, that are used for input.

In addition, the intention of a user may involve multiple dimensions of data, such as a display input that involves multiple kinds of instruction. The multiple dimensions may utilize different input sources in some manner in the mobile device.

However, the various input sources in a mobile device generally do not interrelate, and the operation of one mobile device input elements does not operate easily in conjunction with another mobile device input element. For this, certain functions require sequential input of different kinds of input, or will require a difficult or complex input process.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 illustrates an embodiment of a mobile device to provide cooperative operation of multiple input sources;

FIG. 2 is an illustration of an embodiment of elements of a mobile device providing for cooperative operation of multiple input sources;

FIG. 3 is a state diagram to illustrate transitions for an embodiment of a state machine for a mobile device;

FIG. 4 is a flowchart to illustrate an embodiment of a process for a mobile device to provide for cooperative operation of multiple input sources;

FIG. 5 is a flow chart to illustrate an embodiment of an application for a mobile device using multiple input sources in operation; and

FIG. 6 illustrates an embodiment of a mobile device to provide cooperative operation of multiple input sources.

### DETAILED DESCRIPTION

Embodiments of the invention are generally directed to a multi-dimensional interaction interface for mobile devices.

As used herein:

“Mobile device” means a mobile electronic device or system including a cellular phone, smart phone, mobile Internet device (MID), handheld computers, personal digital assistants (PDAs), and other similar devices.

“Touch sensor” means a sensor that is configured to provide input signals that are generated by the physical contact of a user, proximity of a user, or both (which may generally be referred to as contact with the touch sensor), including a sensor that detects contact by a thumb or other finger of a user of a device or system, including a mobile device. A touch sensor may include, but is not limited to, a capacitive sensor, which may detect the contact of a finger or hand on the capacitive sensor. A touch sensor may include a sensor used for multiple different purposes in the operation of a device or system.

“Side touch sensor” means a touch sensor that detects contact of a user, including a user's finger or hand, on at least one side of a device or system including a mobile device. A side touch sensor includes a touch sensor that is physically located at least in part on one at least one side of the mobile device, or a side touch sensor that detects contact with a user on the side of the mobile device without being physically located on the side on the mobile device.

“Touch screen” means a visual screen that also provides input from contact, such as a user drawing a finger across the screen or selecting a point on the screen.

In some embodiments, a mobile device includes multiple input elements and provides a multi-dimensional interaction interface for the multiple inputs. In some embodiments, the multiple input elements operate cooperatively in providing input to the mobile device. In some embodiments, the multiple inputs to a mobile device include a touch screen signal and a touch sensor signal, including a side touch sensor signal. In some embodiments, the touch screen and touch sensor operate cooperatively in generated a multipoint command for the mobile device.

Mobile devices such as telephones, tablets, and handheld computers generally include main touch screens that commonly provide a two-dimensional (which may be describe in terms of X and Y axis) surface for control. To perform controls in other dimensions, conventional devices require, for example, the use of multiple fingers in a command, or do not provide the ability for the user to be able to perform certain manipulations.

In some embodiments, a mobile device makes use of signals generated by a touch sensor and signals generated by a touch screen in a cooperative manner to provide an additional dimension of control, including, for example, an extra dimension to provide rotation or zooming in relation to a specific point on the screen. These types of operations operations are difficult (or impossible) to accomplish utilizing a conventional single X/Y touch screen input.

In some embodiments, a mobile device uses a touch screen in combination with a side touch sensor. In some embodiments, the operation by the side touch sensor being provided to operate while a mobile device is held in a natural position for one-handed operation, thus leaving the other hand of a user free or to provide on screen manipulations at the same time.

In some embodiments, a mobile device allowing for moving a finger or fingers on the touch screen at the same time as receiving input from a side touch sensor provides an additional level of control of the mobile device. In some embodiments, a mobile device utilizes simultaneous input from the touch screen and the side touch sensor to generate an additional degree of control over mobile device operation. In some embodiments, the mobile device allows an additional dimension of control over the X/Y input to the touch screen.

Examples of simultaneous usages of a touch screen and a side touch sensor include, but are not limited to:

(1) In a first example, a user may utilize the touch screen to enter an anchor point for an image, and simultaneously utilize the side touch sensor to rotate around the anchor point. In this example, a motion up and down on the side touch sensor while anchoring a point of, for instance, a map on the touch screen may allow for rotation of the map image around the point that is being touched on the screen.

(2) In a second example, a user may utilize the touch screen to choose an anchor location for an image and utilize the side touch sensor to zoom in or out in relation to the fixed anchor location on the touch screen.

In some embodiments, these modes and other modes may be implemented by a mobile device apparatus that implements a state machine. In some embodiments, the state machine watches inputs from the touch screen and the side touch sensor, and when data from the touch screen indicates a single touch and hold (or other multidimensional input) is being performed, a movement from the side touch sensor will cause the state machine to send a multipoint message to the application that controls the screen. In some embodiments, the speed and amplitude of the side touch sensor signal values then are used by the application to control, for example, the degree and speed of rotation or zooming in relation to the point held on the touch screen.

In some embodiments, the provision of input to the touch screen of a mobile device causes an input to the side touch sensor to be changed to a function that is related to the input to the side touch sensor. In some embodiments, a touch screen and side touch sensor operate such that an input of a stationary point on the touch screen, or, stated in another way, the anchoring of a point on the touch screen, causes the side touch sensor to provide an input that is related to the point that is input on the touch screen.

In some embodiments, a mobile device may include a module or algorithm for the cooperative usage of multiple inputs. In an example, an algorithm or module may provide for the following operation:

```
While (Wait for events)
begin
  If(event == touch_and_hold)
  Begin
    If(Side Sensor movement is detected while in touch and hold)
      Send_multi_point message to application
    [touchpoint, Side Sensor x, y]
  end
end
```

In some embodiments, a mobile device application may include the following algorithm for the cooperative usage of multiple inputs:

```
While (wait for events)
Begin
  Other events . . .
  If (multi_point_message)
  Begin
    If(in_rotate_mode)
      Begin view rotate operation by amount in multi_point_message
    If( in_zoom_mode)
      Begin zoom operation by amount in multi_point_message
  End
End
```

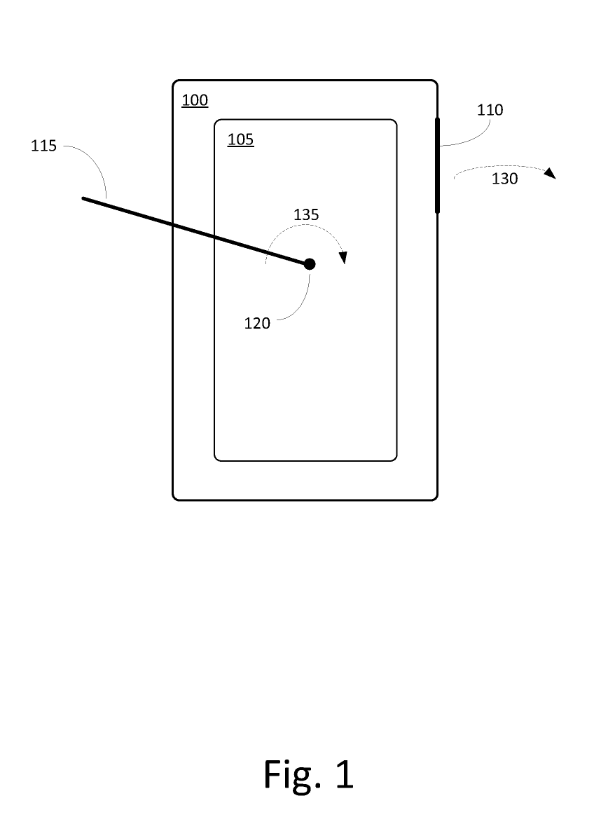

FIG. 1 illustrates an embodiment of a mobile device to provide cooperative operation of multiple input sources. In some embodiments, a mobile device 100 provides for cooperative operation of multiple input sources. In some embodiments, the mobile device 100, which may include a cover, includes a touch screen 105 that provides both for presenting data and images to a user and for receiving input from the user. In some embodiments, the mobile device 100 further includes a side touch sensor 110.

In some embodiments, the mobile device 100 provides cooperative operation of the touch screen 105 and the side touch sensor 110. In some embodiments, when the mobile device is within a certain application or application mode, and either the touch screen or the side touch sensor receives a certain input (such as a touch and hold input to the touch screen or other selection of a point on the touch screen), an input from the other sensor is interpreted as a multipoint input in relation to the first input.

In a particular embodiment, a touch and hold entry 115 to a particular point 120 of the touch screen 105 will cause an input to the side touch sensor 110 to be interpreted as an input in relation to the point 120. In some embodiments, the meaning of the input of the side touch sensor 110 may depend on a mode of the mobile device 100, such as a particular mode in an application being run on the mobile device 100. In this illustration, the mobile device 100 may in a certain mode in which an input the side touch sensor is interpreted as a rotation on the touch screen. Thus, a movement to the right (or left) 130 on the side touch sensor 110 may be interpreted as a rotation clockwise (or counterclockwise) 135.

In some embodiments, the touch sensor 110 may include capacitive sensors and may also include other sensors, such as an optical sensor. See, for example, U.S. patent application Ser. No. 12/650,582, filed Dec. 31, 2009 (Optical Capacitive Thumb Control with Pressure Sensor); U.S. patent application Ser. No. 12/646,220, filed Dec. 23, 2009 (Contoured Thumb Touch Sensor Apparatus).

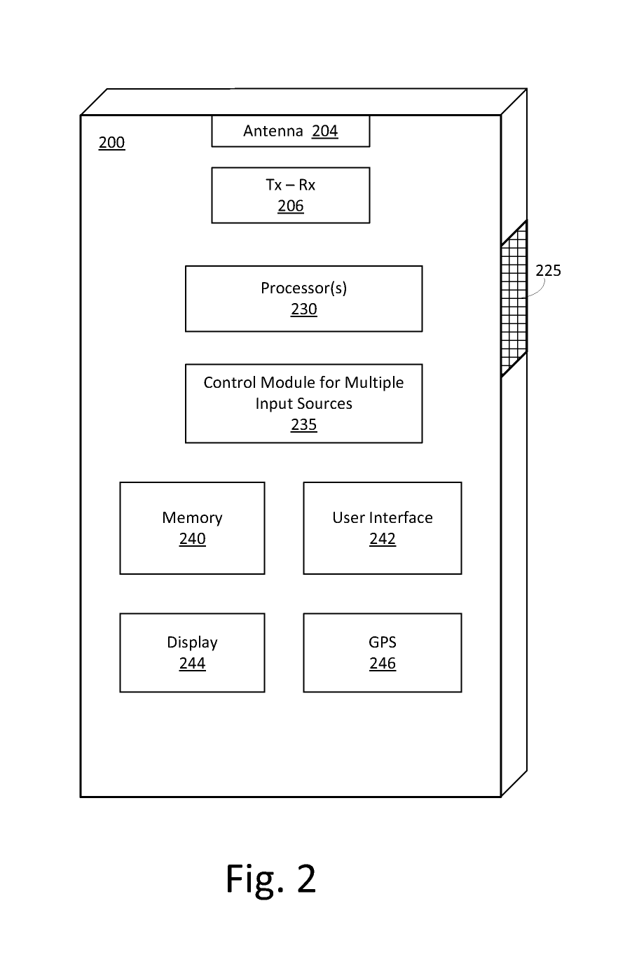

FIG. 2 is an illustration of an embodiment of elements of a mobile device providing for cooperative operation of multiple input sources. In some embodiments, the mobile device 200 includes first touch sensor, the first touch sensor being a touch screen, such as screen 105 in FIG. 1. The touch screen is not illustrated in FIG. 2. In some embodiments, the mobile device 200 includes a second touch sensor, the second touch sensor being a side touch sensor 225 for use in providing input to the mobile device through gesture operations of a thumb or other finger of the user.

In some embodiments, the touch screen and the side touch sensor 225 may operate cooperatively in certain modes to receive multidimensional inputs. For example, as provided above, a touch and hold input or other selection of a point on the touch screen in certain modes will result in an input to the side touch sensor 225 being interpreted as an input in relation to the point.

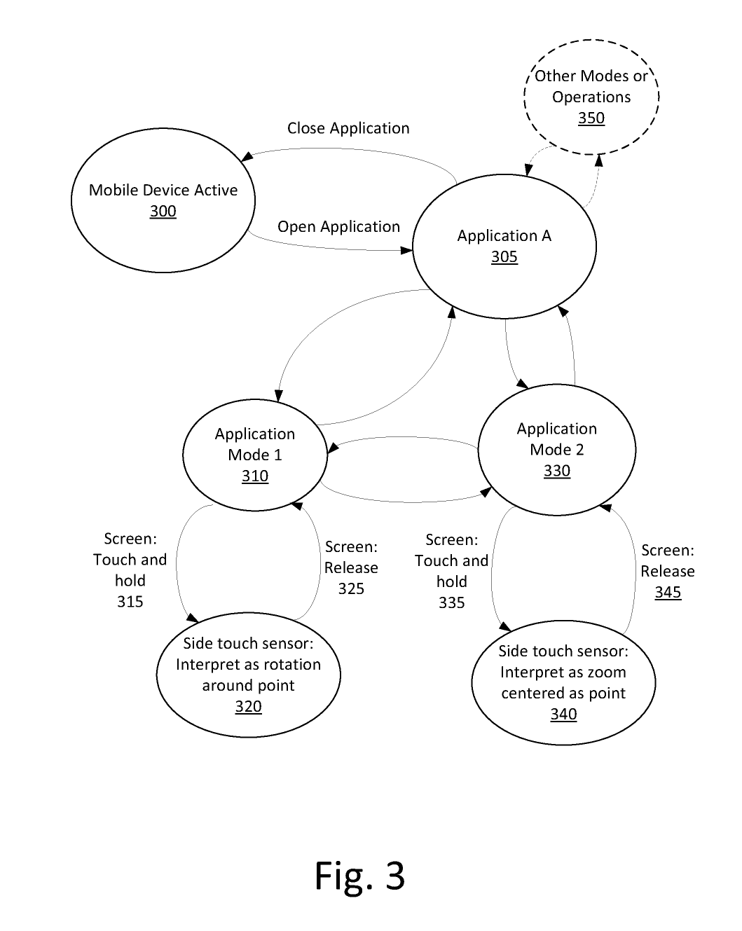

In some embodiments, the mobile device 200 further includes one or more processors 230 for the processing of signals and commands. In some embodiments, the mobile device 200 includes an input control module or algorithm for multiple input sources 235 that receives signals from the touch screen and side screen and provides multidimensional input when the mobile device is in a mode that recognizes such input. In some embodiments, the module or algorithm includes the state machine illustrated in FIG. 3.

The mobile device may further include, for example, one or more transmitters and receivers 206 for the wireless transmission and reception of data, as well as one or more antennas 204 for such data transmission and reception; a memory 240 for the storage of data, including application data; a user interface 242, including a graphical user interface (GUI), for communications between the mobile device 200 and a user of the device; a display circuit or controller 244 for providing the visual display on the touch screen to a user of the mobile device 200; and a location circuit or element, including a (GPS) circuit or element 246.

FIG. 3 is a state diagram to illustrate transitions for an embodiment of a state machine for a mobile device. In some embodiments, a mobile device may be active 300. The mobile device includes one or more applications, including the illustrated Application A 305. Upon opening the application, the mobile device may enter the Application A state, and may leave this state when the application is closed.

While Application A may be any type of application, examples of a possible application may be a mapping application in which a map is displayed on the touch screen or a photographic application in which a photo is displayed on the touch screen. In some embodiments, Application A may include one or more modes, including, for example Application mode 1 310 and Application Mode 2 330. While the modes may vary, in this illustration Mode 1 may be a rotation mode (or a mode that otherwise utilizes screen rotation) and Mode 2 may be a zoom mode (or a mode that otherwise utilizes zooming of a screen image). While the FIG. 3 provides Application Mode 1 310 and Application Mode 2 330 as particular examples, embodiments are not limited to an application operating in these modes, or in utilizing the inputs as provided for these particular modes. In some embodiments, an application may include other modes and operations 350 that utilize the multi-dimensional inputs in different manners.

In some embodiments, while in a state for Application Mode 1 310, upon receiving a selection, such as a touch and hold command, on the touch screen 315 at a particular point the mobile device may enter a state in which an input to the side touch sensor is interpreted as a rotation around the point 320. In one implementation, movements along the X-axis (right-left) of the side touch sensor may be interpreted as rotations. For example, a gesture to the right may be interpreted as a clockwise rotation and a gesture to the left may be interpreted as a counterclockwise rotation (and Y-axis movements (up and down) may be ignored. In some embodiments, upon a release of the point on the touch screen 325 or other deselection of the selected point, the mobile device may leave the rotation state 320.

In some embodiments, while in a state for Application Mode 2 330, upon receiving a touch and hold command or other point selection on the touch screen 335 at a particular point the mobile device may enter a state in which an input to the side touch sensor is interpreted as zooming in or out of the image in relation to the point 340. In one implementation, movements along the Y-axis (up-down) of the side touch sensor may be interpreted as zooming operations. For example, a gesture down may be interpreted as zooming in to the point and a gesture up may be interpreted as zooming out from the point (and X-axis movements (right-left) may be ignored. In some embodiments, upon a release of the point or other deselection of the point on the touch screen 345, the mobile device may leave the zoom state 340.

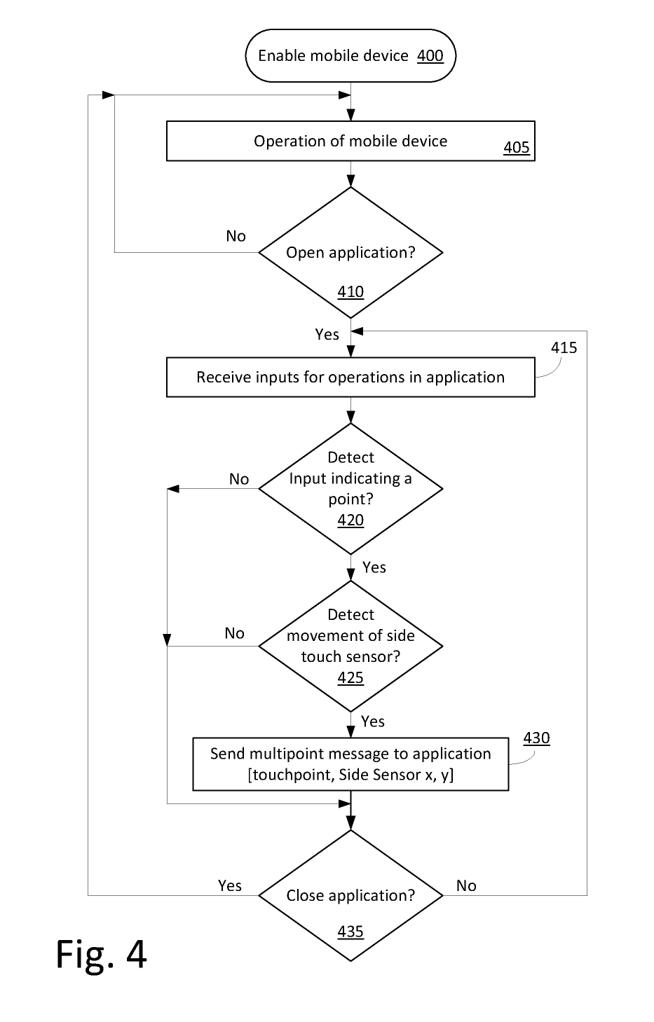

FIG. 4 is a flowchart to illustrate an embodiment of a process for a mobile device. In some embodiments, a mobile device may be enabled 400, and the operation of the mobile device commenced 405. Upon opening an application 410 that utilizes multipoint messaging, one or more inputs may be received for operations in the application 415.

If a touch and hold input (or other input to establish a multiple dimension input state) is received 420, and gesture movement is detected by the side touch sensor 425 (which may be limited to certain gestures, such as movement in a particular axis), then a multipoint message is sent to the application 430, where the multipoint message may be in the form [touchpoint, side sensor x, y]. If the application is not closed 435, the process may continue with more inputs for operations in the application 415. If the application is closed, the mobile device may return to operations of the mobile device.

While not illustrated here, the mobile device may include multiple different functions, applications, and modes, and each may or may not recognize multiple dimension inputs, and, if recognized, these inputs may be interpreted in different ways by each function, application, or mode.

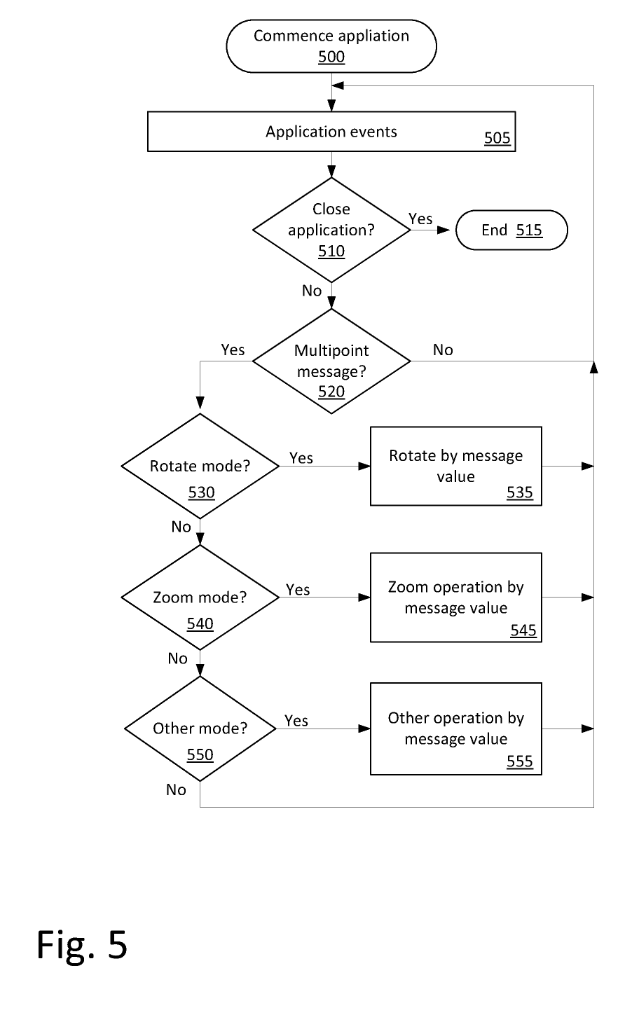

FIG. 5 is a flow chart to illustrate an embodiment of an application for a mobile device using multiple input sources in operation. In some embodiments, upon opening a particular application 500 there may be certain application events 505. If the application remains open 510, and a multipoint message is received 520, where the message includes a certain message value, then the response to the multipoint message may depend on the current mode of the application. If the application is in a rotate mode 530, then the screen will be rotated by an amount represented by the message value 535. If the application is in a zoom mode 540, then the screen will be zoomed in or out by an amount represented by the message value 545. If the application is in another mode that recognizes a multipoint message 550, the screen may be affected by some operation by the message value 555. Subsequent to the multipoint message operation, the application may return to application events 505, until the application is closed 510, resulting in the end of the illustrated operation 515.

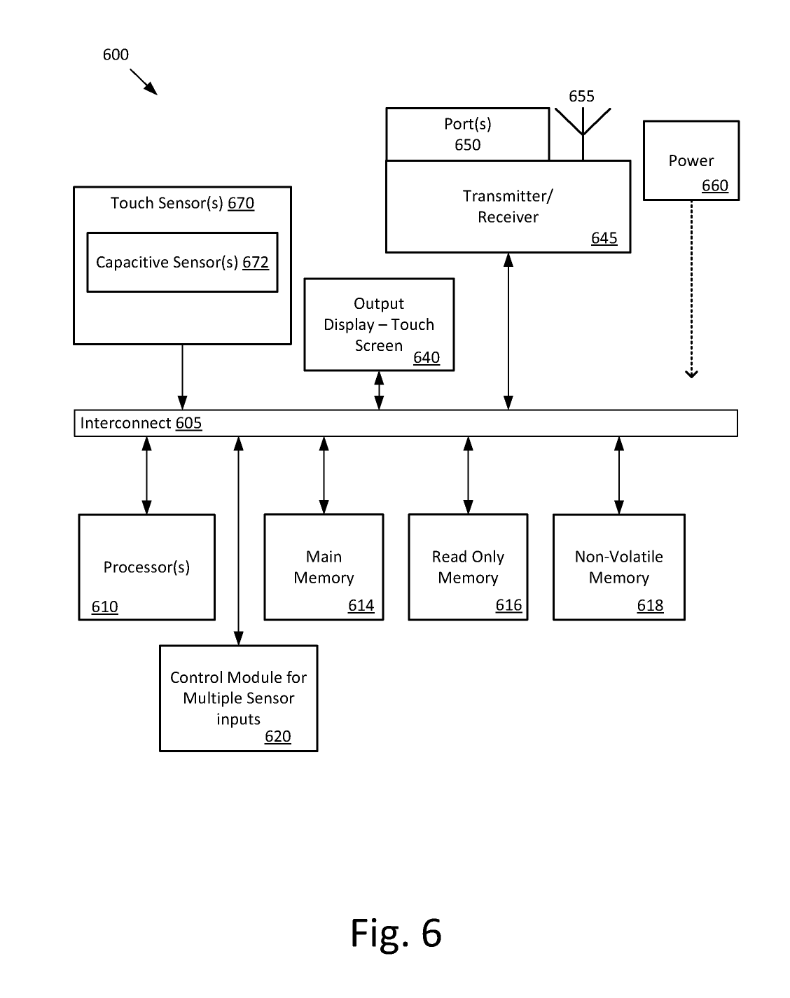

FIG. 6 illustrates an embodiment of a mobile device to provide cooperative operation of multiple input sources. In this illustration, certain standard and well-known components that are not germane to the present description are not shown. Under some embodiments, the mobile device 600 comprises an interconnect or crossbar 605 or other communication means for transmission of data. The device 600 may include a processing means such as one or more processors 610 coupled with the interconnect 605 for processing information. The processors 610 may comprise one or more physical processors and one or more logical processors. The interconnect 605 is illustrated as a single interconnect for simplicity, but may represent multiple different interconnects or buses and the component connections to such interconnects may vary. The interconnect 605 shown in FIG. 6 is an abstraction that represents any one or more separate physical buses, point-to-point connections, or both connected by appropriate bridges, adapters, or controllers.

In some embodiments, the device 600 includes one or more touch sensors 670. In some embodiments, the touch sensors 670 may includes capacitive sensors 672, and may include one or more other sensors, such as optical sensors. The touch sensors 670 may include a side touch sensor, such as side touch sensor 110 as illustrated in FIG. 1.

The device 600 may also include an output display 640 coupled via the interconnect 605, where the display is a touch screen that may receive input from contact by a user and thus is also utilized as at least a part of an input device. In some embodiments, the display 640 may include a liquid crystal display (LCD) or any other display technology, for displaying information or content to a user. In some environments, the mobile device 600 may also include an audio device, such as a speaker for providing audio information.

In some embodiments, the mobile device may provide for receipt of multidimensional input in at least some states, where the multidimensional input may include an input from the touch screen 640 and the touch sensor 670. In some embodiments, the device 600 includes a control module for handling multiple sensor inputs.

In some embodiments, the device 600 further comprises a random access memory (RAM) or other dynamic storage device or element as a main memory 614 for storing information and instructions to be executed by the processors 610, including storage of applications that may utilize multi-dimensional input from the touch screen 640 and touch sensors 670. RAM memory includes dynamic random access memory (DRAM), which requires refreshing of memory contents, and static random access memory (SRAM), which does not require refreshing contents, but at increased cost. DRAM memory may include synchronous dynamic random access memory (SDRAM), which includes a clock signal to control signals, and extended data-out dynamic random access memory (EDO DRAM). In some embodiments, memory of the system may include certain registers or other special purpose memory. The device 600 also may comprise a read only memory (ROM) 616 or other static storage device for storing static information and instructions for the processors 610. The device 600 may include one or more non-volatile memory elements 618 for the storage of certain elements.

One or more transmitters or receivers 645 may also be coupled to the interconnect 605. In some embodiments, the device 600 may include one or more ports 650 for the reception or transmission of data. The device 600 may further include one or more antennas 655 for the reception of data via radio signals.

The device 600 may also comprise a power device or system 660, which may comprise a power supply, a battery, a solar cell, a fuel cell, or other system or device for providing or generating power. The power provided by the power device or system 660 may be distributed as required to elements of the device 600.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. There may be intermediate structure between illustrated components. The components described or illustrated herein may have additional inputs or outputs which are not illustrated or described.

Various embodiments may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments may be provided as a computer program product, which may include a computer-readable medium having stored thereon computer program instructions, which may be used to program a computer (or other electronic devices) for execution by one or more processors to perform a process according to certain embodiments. The computer-readable medium may include, but is not limited to, floppy diskettes, optical disks, compact disk read-only memory (CD-ROM), and magneto-optical disks, read-only memory (ROM), random access memory (RAM), erasable programmable read-only memory (EPROM), electrically-erasable programmable read-only memory (EEPROM), magnet or optical cards, flash memory, or other type of computer-readable medium suitable for storing electronic instructions. Moreover, embodiments may also be downloaded as a computer program product, wherein the program may be transferred from a remote computer to a requesting computer.

Many of the methods are described in their most basic form, but processes can be added to or deleted from any of the methods and information can be added or subtracted from any of the described messages without departing from the basic scope of the present invention. It will be apparent to those skilled in the art that many further modifications and adaptations can be made. The particular embodiments are not provided to limit the invention but to illustrate it. The scope of the embodiments of the present invention is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example of the present invention. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments of the present invention, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

1. A mobile device comprising:
a touch screen to provide a display and to generate a touch screen signal upon contact to the touch screen;
a touch sensor to generate a touch sensor signal upon contact with the touch sensor; and
a module to provide for cooperative operation of the touch screen signal and the touch sensor signal in providing input to the mobile device upon determining that an input to the touch screen indicates a multipoint input.

2. The mobile device of claim 1, wherein the module includes a state machine to provide for states to handle multiple input sources.

3. The mobile device of claim 1, wherein the input to the mobile device provides an additional dimension of control over the input to the touch screen.

4. The mobile device of claim 1, wherein the input to the touch screen is an input to select a first point on the touch screen.

5. The mobile device of claim 4, wherein the input to the touch screen is an input to touch and hold the first point on the touch screen.

6. The mobile device of claim 4, wherein an input to the touch sensor is interpreted as a command in relation to the first point.

7. The mobile device of claim 6, wherein the command is a command to rotate the display on the touch screen around the first point.

8. The mobile device of claim 6, wherein the command is a command to zoom the display in or out from the first point.

9. The mobile device of claim 1, wherein the touch sensor is a side touch sensor to detect contact with a side of the mobile device.

10. A method comprising:
receiving an input to a touch screen of a mobile device, wherein the input to the touch screen is an input to indicate a cooperative input with another input;
receiving an input to a touch sensor of the mobile device;
entering a state to receive multipoint data; and
interpreting the input to the touch sensor as a command in relation to the input to the touch screen.

11. The method of claim 10, further comprising providing an additional dimension of control in the command over the input to the touch screen.

12. The method of claim 10, wherein receiving the input to the touch screen includes receiving an input to select a first point on the touch screen.

13. The method of claim 12, wherein the input to the touch sensor is interpreted as a command in relation to the first point.

14. The method of claim 13, wherein the command is a command to rotate a display on the touch screen around the first point.

15. The method of claim 13, wherein the command is a command to zoom a display on the touch screen in or out from the first point.

16. The method of claim 12, further comprising leaving the state to receive multipoint data upon detecting a deselection of the first point on the touch screen.

17. The method of claim 10, wherein the touch sensor is a side touch sensor to detect contact for a side of the mobile device.

18. A system comprising:
a touch screen to provide a display and to generate a touch screen signal upon contact with the touch screen;
a side touch sensor to generate a touch sensor signal upon contact with a side of the system;
a dynamic random access memory (DRAM) to hold an application for the system; and
a module to provide for cooperative operation of the touch screen signal and the touch sensor signal in providing input to the mobile device for the application upon determining that an input to the touch screen indicates a multipoint input.

19. The system of claim 18, wherein the module includes a state machine to provide for states to handle multiple input sources.

20. The system of claim 18, wherein the input to the touch screen is an input to select a first point on the touch screen.

21. The system of claim 20, wherein an input to the side touch sensor is interpreted as a command in relation to the first point.

22. The system of claim 21, wherein the command is a command to rotate the display on the touch screen around the first point.

23. The system of claim 21, wherein the command is a command to zoom the display in or out from the first point.

24. A non-transitory computer-readable medium having stored thereon data representing sequences of instructions that, when executed by a processor, cause the processor to perform operations comprising:
receiving an input to a touch screen of a mobile device, wherein the input to the touch screen is an input to indicate a cooperative input with another input;
receiving an input to a touch sensor of the mobile device;
entering a state to receive multipoint data; and
interpreting the input to the touch sensor as a command in relation to the input to the touch screen.

25. The medium of claim 24, wherein receiving the input to the touch screen includes receiving an input to select a first point on the touch screen.

26-29. (canceled)
